(19) United States
(12) Patent Application Publication
(10) Pub. No.: US 2016/0175780 A1
(43) Pub. Date: Jun. 23, 2016

(54) GAS MIXTURE AND METHOD FOR ELECTRIC ARC JOINING OR MATERIAL PROCESSING WITH REDUCED POLLUTANT EMISSION

(71) Applicants: Ernst Miklos, Kirchheim (DE); Wilhelm Bayerl, Sauerlach (DE)

(72) Inventors: Ernst Miklos, Kirchheim (DE); Wilhelm Bayerl, Sauerlach (DE)

(21) Appl. No.: 14/966,661

(22) Filed: Dec. 11, 2015

(30) Foreign Application Priority Data
Dec. 17, 2014 (DE) 10 2014 018 884.1

(51) Int. Cl. B01F 3/02; F17C 1/00; B23K 35/38

(52) U.S. Cl. CPC B01F 3/02; B23K 35/38; F17C 1/00

(57) ABSTRACT

A gas mixture, a pressure tank containing the gas mixture, a method that uses the gas mixture during thermal spraying, cutting, joining, deposition welding and/or surface treatment by means of arcs, plasma and/or lasers, a device for preparing the gas mixture and a method for manufacturing the gas mixture are disclosed, wherein the gas mixture contains a protective gas and a protective gas additive selected from the group of ethers, cyclic amines containing at least one ether group, and mixtures thereof.

### CROSS REFERENCE TO RELATED APPLICATIONS

The present application claims priority from German Patent Application DE 102014018884.1 filed on Dec. 17, 2014.

### BACKGROUND OF THE INVENTION

The invention relates to a gas mixture and a method for thermal spraying, cutting, joining, deposition welding and/or surface treatment by means of arcs, plasma and/or lasers, which utilize the gas mixture.

Known in the art is to add reactive gaseous or vaporous substances to the protective gas, so as to improve various properties while welding and in the weld metal. Among other things, U.S. Pat. No. 3,470,346 describes the addition of alcohol to a protective gas mixture of argon and helium.

The object of the invention is to enable high-quality joints and improve the thermal spraying, cutting, joining, deposition welding and/or surface treatment by means of arcs, plasma and/or lasers.

### SUMMARY OF THE INVENTION

It was surprisingly discovered that adding an ether or a cyclic amine containing an ether group to conventional protective gases, such as argon, helium, nitrogen, carbon dioxide or hydrogen or mixtures thereof, significantly increases the efficiency of thermal spraying, cutting, joining, deposition welding and/or surface treatment by means of arcs, plasma and/or lasers, and yields high-quality welded seams and soldered seams with a fine-grained composition.

Accordingly, the invention relates to a gas mixture, encompassing a protective gas, which exhibits carbon dioxide and/or oxygen and/or hydrogen and/or nitrogen along with at least one inert component selected from the group of argon, helium, argon-helium mixtures and other noble gases and mixtures thereof, as well as mixtures of other noble gases with argon and/or helium, and a protective gas additive, which is selected from the group of ether or cyclic amines containing at least one ether group or mixtures thereof.

The invention further relates to an industrial processing method, in which a gas mixture is used for thermal spraying, cutting, joining, deposition welding and/or surface treatment by means of arcs, plasma and/or lasers, characterized in that the gas mixture is the gas mixture mentioned above.

Another subject matter of the invention relates to a device for preparing the gas mixture according to the invention, encompassing a tank with liquid argon, nitrogen, carbon dioxide, hydrogen or helium or mixtures thereof and/or one or more pressure tanks with argon, nitrogen, carbon dioxide, hydrogen or helium or mixtures thereof, a container that holds the protective gas additive, if necessary dissolved in a solvent, and a line that introduces argon, nitrogen, carbon dioxide, hydrogen or helium or mixtures thereof into the gas compartment of the container, or guides it through the liquid in the container, and relays the resultant gas mixture to a consumer.

Finally, the invention also relates to a method for manufacturing the gas mixture according to the invention characterized in that a protective gas additive is filled into a pressure tank along with argon, nitrogen, carbon dioxide, hydrogen or helium or mixtures thereof.

The protective gas is usually selected from Ar, He, CO₂, H₂, N₂ or air or mixtures thereof, Special preference goes to Ar and mixtures of Ar and He, Ar and CO₂, Ar and N₂, Ar and H₂, as well as to the last three mixtures mentioned that also contain He.

Carbon dioxide and hydrogen are preferably used mixed in with Ar, He, N₂, air or a mixture thereof. Carbon dioxide is here present in amounts normally ranging from 1 to 80% v/v, preferably 2 to 50% v/v, especially preferably 5 to 20% v/v. Oxygen can further also be admixed in amounts normally ranging from 1 to 30% v/v, preferably 2 to 20 %v/v. In this case, oxygen is added on site under no pressure.

Carbon dioxide, hydrogen and oxygen can also be admixed in doping quantities ranging from 10 vpm to 10000 vpm (0.001 to 1.0% v/v), preferably 100 to 1000 vpm. The same also holds true for nitrogen monoxide and nitrous oxide (N₂O).

The ethers can be selected from all linear or branched aliphatic, cycloaliphatic or aromatic ethers or nitrogenous heteroethers with a melting point of ≦5° C.

The gaseous hydrocarbons generally make up from 0.0001% v/v (1 vpm) to 10% v/v, preferably ranging from 0.001% v/v (10 vpm) to 5% v/v, especially preferably ranging from 0.01% v/v (100 vpm) to 0.1% v/v (1000 vpm), especially preferably ranging from 0.0001% v/v (1 vpm) to less than 0.1% v/v (1000 vpm) of the protective gas additive relative to the gas mixture according to the invention. The quantities used in a special case depend on the type of method and materials processed.

Dimethyl ether and ethyl methyl ether are gaseous at room temperature, and can be easily mixed with the protective gas. For this reason, they are preferred.

The term ether relates to ethers with a single ether group, as well as to ethers with two or more ether groups.

The higher ethers and starting from diethyl ether, which is also preferred, and nitrogenous heteroethers with a melting point of ≦5° C. are liquid at room temperature.

Apart from the linear aliphatic ethers, such as dimethyl ether, ethyl methyl ether, diethyl ether, ethyl propyl ether, dipropyl ether, dimethoxyethane and higher linear ethers, use can also be made of branched ethers, such as diisopropyl ether and diisobutyl ether, and cyclic ethers, such as tetrahydrofuran, tetrahydropyran and 1,4-dioxane.

For example, the usable aromatic ethers include anisole. Morpholine is one example for a cyclic amine containing an ether group.

For the sake of simplicity, the cyclic amines containing an ether group will also be referred to as ethers below. To improve readability, the wording “if an ether, in particular dimethyl ether, ethyl methyl ether and/or diethyl ether, is added to the protective gas”, will also encompass the more general, but linguistically more cumbersome wording according to which the “protective gas, which is selected from the group of ethers, cyclic amines containing at least one ether group, and mixtures thereof”. This holds true in particular for passages in the text that report about the surprising test results.

The advantage to ether protective gas additives over alcohol protective gas additives is that the former additives exhibit a lower melting point and boiling point at a similar molecular weight.

### DETAILED DESCRIPTION OF THE INVENTION

In a preferred embodiment, the protective gas with an ether additive liquid at room temperature is prepared by allowing at least one component of the protective gas to flow through a preparatory liquid, which consists of the ether protective gas additive. However, it is also possible to apply this preparation for ether that is gaseous at ambient temperature by cooling the ether protective gas additive, so that it is present in a liquid form. Slight cooling will be advantageous even for highly volatile compounds, such as diethyl ether. It is also possible to dissolve the ether protective gas additive in a solvent that exhibits a lower vapor pressure than the ether, for example in higher hydrocarbons or water, and use this solution as the preparatory liquid. At least one component of the protective gas is now guided into this preparatory liquid. Argon, carbon dioxide or helium are advantageously introduced, but the other possible components or a mixture thereof can also be guided into the preparatory liquid. When flowing through the preparatory liquid, the gas takes up the ether protective gas additive, and a gas mixture comes about, which contains the ether protective gas additive in the desired concentration, either directly or after mixing with additional components, or even after diluted, and now is used as a protective gas with ether additive for thermal spraying, cutting, joining, deposition welding and/or surface treatment by means of arcs, plasma and/or lasers.

In order to be able to reproducibly and reliably set a specific concentration, the preparatory liquid is advantageously temperature controlled. Keeping the preparatory liquid at a constant temperature ensures that the concentration of the ether in the gas will remain uniform. Since the concentration with which the ether is present in the gas after enrichment depends on the temperature, it is possible to set the concentration of the ether in the gas via temperature control. Temperature control may advantageously involve selecting a temperature both above and below the ambient temperature. In particular given highly volatile ethers or ethers with boiling points close to the ambient temperature, it is advantageous to select a temperature below the ambient temperature, while a temperature above the ambient temperature may be advantageous for higher boiling ethers, so that enough particles are converted into the gas. As a consequence, temperature control makes it possible to set the concentration of ethers in the gas by selecting the temperature.

In an alternative, advantageous embodiment of the method according to the invention, the ether protective gas additive is mixed as a gas with the other component(s) to yield the welding protective gas mixture. If necessary, the ether protective gas additive is converted into the gas phase through heating to this end, If the ether protective gas additive is already present in gaseous form, heating does not take place. The gaseous ether protective gas additive is mixed with the other component(s) to yield the finished protective gas mixture with ether additive. This method is especially recommended for ether protective gas additives that are already present in gaseous form at an ambient temperature, or exhibit a boiling point close to the ambient temperature.

In both cases, it is possible to either blend the ether protective gas additive with the individual other components or the otherwise finished protective gas mixture, or to first just blend the ether protective gas additive with one component, and then dilute it or add the remaining components.

For example, apart from these two preferred methods of preparation, it is also possible to extract vapor by way of a preparatory liquid, or mix the liquid ether protective gas additive with another component of the protective gas present in liquid form, e.g., with liquid argon or liquid carbon dioxide, so as to obtain the protective gas. However, it is here most often harder to set the concentration of the ether protective gas additive in the protective gas.

In an advantageous embodiment of the invention, the protective gas is manufactured on site. During on-site manufacture, the components of the protective gas can be provided by the gas supplier in gaseous or liquid form. However, the finished protective gas mixture can also be filled into gas cylinders at the gas manufacturer, and then delivered.

During thermal spraying, cutting, joining, deposition welding and/or surface treatment by means of arcs, plasma and/or lasers (a plasma also arises in the arc and usually also in the laser), the objective of the plasma is to convey heat to the material in a controlled manner. Since the theory of plasmas is exceedingly difficult, the exact processes in the plasmas generated during the cited method are not well known and hard to predict.

Without being tied to a theory, it is assumed that, in the case of noble gas plasmas, heat is generated by virtue of the fact that electrons and positively charged ions recombine into atoms on the one hand, and the atoms release energy through collision on the other.

In plasmas involving the participation of H₂ or N₂ molecules, it is assumed that energy can further be released by combining atoms into molecules.

It was surprisingly found that the ether protective gas additives used according to the invention increase the energy of the gas mixtures in particular.

The percentage level of respective energy that causes the material to heat up here depends on the special conditions of the plasma, and is hard to predict.

Doping gas mixtures with small quantities of CO₂, NO, N₂O and O₂ in particular during arc joining is known in the art (e.g., see EP 0 544 187 32, EP 0 639 423 B1 and EP 0 640 431 B1). Among other things, doing so stabilizes the arc, improves energy introduction with a laser, and generally improves the quality. This is surprisingly also observed in the presence of small quantities of the ether protective gas additive used according to the invention.

For example, CO₂, Nd-YAG, diode, disk or fiber lasers are used for laser processing.

The thermal spraying methods involving the use of the gas mixtures according to the invention break down into arc spraying, plasma spraying and laser spraying.

In arc spraying, two wire-shaped, electrically conductive spray materials are continuously fed toward each other at a specific angle. After ignition, an arc burns between the two spray wires (electrodes) at a high temperature, and melts away the spray material. A strong gas stream atomizes the melt, and accelerates the spray particles toward the workpiece surface, where they form a coating. For process-related reasons, only metallically conductive, wire-shaped spray materials can be processed. Air can be used as the atomizer gas, but nitrogen and/or argon are commonly used.

Layers applied in the arc method are distinguished by a very good adhesion. The spray particles become tottered with the base material. The method is especially suited for applications that require thick coatings or involve large surfaces.

For example, the applied layers can be used as insulation, wear protection, and slide bearings.

It has now been surprisingly discovered that the spraying speed can be further increased by adding ether to the atomizer gas, in particular dimethyl ether, ethyl methyl ether and/or diethyl ether, or that the application rate is increased, i.e., thicker layers can be deposited. The quality of the coating is also improved.

Plasma spraying is another thermal spraying process. In this method, an anode and up to three cathodes are separated by a narrow gap in a plasma torch. A direct voltage generates an arc between the anode and cathode. The gas or gas mixture flowing through the plasma torch is guided through the arc, and dissociated and ionized in the process. The dissociation and ionization generate a highly heated, electrically conductive plasma (gas comprised of positive ions and electrons). A powder is introduced into this plasma jet through a nozzle, and melted by the high plasma temperature. The process gas stream (plasma gas stream) entrains the powder particles, and throws them against the workpiece to be coated. The extremely high temperature (up to 30,000° C.) makes it possible to process nearly all materials, even refractory materials. (e.g., ceramics).

For example, plasma spray layers can be very hard, wear resistant, nearly dense layers with a very good chemical stability.

The gas mixture in the plasma coating can simultaneously serve as a transport gas and protective gas. As a rule, the gases used are argon, nitrogen, hydrogen or helium and mixtures thereof.

It has now been surprisingly discovered that adding ethers, in particular dimethyl ether, ethyl methyl ether and/or diethyl ether, to the gas mixture(s) can elevate the spraying speed or increase the application rate, i.e., allow the deposition of thicker layers. The quality of the coating is also improved. Adding ethers, in particular dimethyl ether, also makes it possible to positively influence the carbon content in coatings, which in turn improves the properties of the layer material or sprayed on layer from a mechanical and tribological standpoint.

Laser spraying is another thermal spraying process. In laser spraying, a spray additive present in powder form is introduced into the laser beam focused on the workpiece through a nozzle, and thrown onto the material surface with the help of a gas. A plasma forms in the focal spot of the laser, which both fuses the powder and a minimal portion of the material surface, and metallurgically bonds the supplied spray additive with the material.

It has now been surprisingly discovered that adding ethers, in particular dimethyl ether, ethyl methyl ether and/or diethyl ether, to the gas mixture as in the preceding thermal spraying processes can elevate the spraying speed or increase the application rate, i.e., enable the deposition of thicker layers, while at the same time improving the quality of the coating.

Thermal separation or cutting here refers to plasma cutting and laser beam cutting.

Plasma cutting is a thermal separation process, in which the plasma arc melts and/or evaporates and even partially burns the base material. Plasma arc is a term used to denote an ionized and dissociated gas jet that has been constricted by a cooled nozzle. Constriction yields a plasma jet with a high energy density. The base material interacts with the plasma jet, and is expelled from the arising kerf by the plasma gas. The cooling of the nozzle required for constriction usually takes place either by means of water and/or by means of a gas mixture, which is referred to as a secondary gas, protective gas or enveloping gas, which envelops the plasma jet. One variant of plasma cutting is fine jet-plasma cutting, in which the plasma jet is very strongly constricted. The molten material is expelled by the high kinetic energy of the gas mixture forming the plasma (also referred to as plasma gas). When using a gas mixture that serves as a secondary gas or protective gas, the latter also blows out the liquid material. Argon, nitrogen, hydrogen and sometimes even helium along with mixtures thereof are used as gas mixtures for generating the plasma. In many cases, oxygen is also added to this gas mixture, wherein the oxygen can lead to an oxidation reaction with the material, and thereby introduce additional energy. Compressed air is also used as the gas. Carbon dioxide is sometimes also added. If another gas mixture is used, i.e., a secondary gas, a gas or a gas mixture comprised of the gases just mentioned is also used for the latter. The selection of gas or gas composition is determined by the procedural variant, and primarily by the thickness and type of the material to be cut.

It has now been discovered that the cutting speed can be significantly increased in cases where an ether, in particular dimethyl ether, ethyl methyl ether and/or diethyl ether, is further added to one of the aforementioned gas mixtures (plasma gas, secondary gas) comprised of argon, helium, nitrogen or hydrogen or a mixture thereof. In addition, the quality of the kerf is improved.

In laser beam cutting, a laser beam is used as the cutting tool. To this end, the laser beam is guided toward the processing site. When laser cutting with inert or weakly reacting gases as the cutting gases, no or virtually no chemical reaction takes place with the base material. The melted material is expelled from the kerf with the cutting gas during laser beam cutting. As a consequence, nitrogen, argon and/or helium are most often used as the cutting gas. Compressed air is also used. The laser beam is an ideal tool for cutting metal and nonmetal materials with smaller thicknesses. However, the cutting speed of the laser beam drops off greatly as material thickness increases.

It has now been surprisingly discovered that an added ether, in particular dimethyl ether, ethyl methyl ether and/or diethyl ether, breaks down in the kerf, thereby introducing more energy into the joint. As a result, the cutting speed of the laser beam is significantly increased. In addition, it is also possible to separate thicker materials at cutting rates that are economically satisfactory. The composition of the kerf is also improved, and there is even less of a need for post-processing. In other words, productivity increases,

Welding for materially bonding metal workpieces has been practiced for a long time. The workpieces to be joined together are melted in the welding process. During metal-protective gas welding, an arc burns in a protective gas coating. Arc welding with a fusing electrode includes metal-inert gas welding (MIG welding) and metal-active gas welding (MAC welding), and without a fusing electrode includes tungsten-inert gas welding (WIG welding). Tungsten-plasma welding (WP welding) further represents an additional procedural variant of arc welding under a protective gas with a non-fusing electrode. Also known are hybrid methods and welding with several electrodes, and in particular tandem welding. Protective gas mixtures for welding with arcs exist in numerous different mixtures, wherein the individual mixtures are optimized for the respective welding method and material. The focus is here placed on a stable arc, a high-quality welded seam, the avoidance of pores and weld spatters, and a high processing rate. The most common protective gases are argon, helium, nitrogen and hydrogen, along with mixtures thereof.

Soldering refers to a thermal process for materially bonding materials in which a liquid phase is produced by melting a solder (solder filler metal). As opposed to welding, soldering does not yield the solidus temperature of the workpieces to be joined. To be mentioned in this regard are the various arc soldering methods MIG, MAG, WIG along with plasma and plasma-MIG soldering and hybrid soldering processes. In the hard soldering process, which takes place with arcs and under a protective gas, the soldered joint is normally generated with the use of protective gas welding tools. However, the base material is here not fused in the process, but rather only the so-called hard and high temperature solders used as filler metals. The used solder materials have comparatively low melting points on the order of about 1000° C. Often used as solder materials are bronze wires, which consist of copper-based alloys with different alloying elements, such as aluminum, silicon or tin. The used protective gases are the same as during arc welding.

Soldering can also be used to fabricate bonds out of different types of materials, wherein the advantages to soldering enumerated above apply here as well. Given different types of materials, a mixture of welding and soldering is also possible, in which the weld pool is formed by the material with a lower melting point and solder filler metal, and the material with the higher melting point is only heated, but not melted.

It has now been surprisingly discovered that the joining speed and quality of the welded or soldered seam can be significantly improved by adding an ether to the protective gas, in particular dimethyl ether, ethyl methyl ether and/or diethyl ether. In addition, the energy input into the weld/solder pool is improved by the ether.

In plasma joining (welding and soldering), a plasma jet serves as the heat source. The plasma jet is generated by ionizing and constricting an arc. The latter burns between a non-fusing negative (tungsten) electrode and the workpiece as a so-called primary arc (directly transferred arc). In addition, a pilot arc can be used for the ignition process between a non-fusing negative (tungsten) electrode and an anode designed as a nozzle. For example, the so-called primary arc (plasma jet) used for welding can be moved along a desired welded seam progression. A plasma torch is used to supply up to three gases or gas mixtures, specifically the so-called plasma gas, if necessary a so-called secondary gas or focusing gas for constricting the plasma jet, and the so-called protective gas, which envelops the plasma jet or plasma jet and secondary gas as the protective gas coating,

Keyhole plasma welding is a variant of plasma welding. Keyhole plasma welding is used for thinner metal sheets. This method is predominantly employed in container and apparatus construction, and in pipeline construction.

In keyhole plasma welding, the plasma jet penetrates through the entire workpiece thickness at the start of the welding process. The weld pool produced by fusing the workpiece is here pressed to the side by the plasma jet. The surface tension of the melt prevents a fall through the keyhole. Instead, the melt converges once again behind the forming welding eye, and solidifies into the welded seam.

Microplasma welding is used in particular for thin and thinnest metal sheet thicknesses.

It has now been surprisingly discovered that adding an ether to one or more of the mentioned gas mixtures (plasma and/or secondary and/or protective gas) leads to a remarkable rise in the welding/soldering speed, as well as to an improved welded/soldered seam.

It has also been surprisingly found that already small quantities of ether, and in particular of dimethyl ether, ethyl methyl ether and/or diethyl ether, ranging from about 10 vpm to about 5000 vpm, preferably from about 100 vpm to about 1000 vpm, exhibit the inventive advantages, and that a more stable process is achieved and higher joining speeds are enabled in particular when arc joining, but also when plasma joining.

There are combined arc/laser joining methods, so-called hybrid methods. Here as well, it is advantageous to add an ether, in particular dimethyl ether, ethyl methyl ether and/or diethyl ether.

In deposition welding, a coating material is welded onto a material.

Surface treatment includes surface treatment with plasma, such as surface activation, surface pretreatment, surface treatment, surface functionalization and surface cleaning. The plasma can be an open plasma as in a WIG torch, a constricted plasma as in a plasma torch, or a plasma in a plasma chamber.

Adding an ether, in particular dimethyl ether, ethyl methyl ether and/or diethyl ether, also strongly improves the efficiency in these latter two methods.

It is advantageous to use the method according to the invention for unalloyed, low-alloyed and high-alloyed steels, nickel-based materials and aluminum and aluminum alloys. However, it can also be used for other materials, such as magnesium and magnesium alloys and cast iron.

The present invention offers an entire range of advantages, only a handful of which can be mentioned below. The energy input into the material can be advantageously reduced in arc joining, for example. The metal vapors arising in most of the mentioned processes are diminished, since using the gas mixture according to the invention inhibits their formation.

What we claim is:

1. A gas mixture comprising a protective gas selected from the group consisting of carbon dioxide, oxygen, hydrogen, nitrogen and mixtures thereof along with at least one inert component selected from the group consisting of argon, helium, argon-helium mixtures and noble gases and mixtures thereof, and mixtures of noble gases with argon and/or helium, and further comprising a protective gas additive selected from the group consisting of ethers, cyclic amines containing at least one ether group, and mixtures thereof.

2. The gas mixture according to claim 1, characterized in that the protective gas is selected from the group of dimethyl ether, ethyl methyl ether, diethyl ether and mixtures thereof.

3. The gas mixture according to claim 1, characterized in that the gas mixture contains from 0.0001% v/v to 10% v/v of the protective gas additive relative to the gas mixture.

4. The gas mixture according to claim 1, characterized in that the gas mixture contains from 0.001% v/v to 5% v/v of the protective gas additive relative to the gas mixture.

5. The gas mixture according to claim 1, characterized in that the gas mixture contains from 0.01% v/v to 0.1% v/v of the protective gas additive relative to the gas mixture.

6. The gas mixture according to claim 1, characterized in that the gas mixture contains from 0.0001% v/v to less than 0.1% v/v of the protective gas additive relative to the gas mixture.

7. The gas mixture according to claim 1, characterized in that it is present in a pressure tank.

8. The gas mixture according to claim 1, characterized in that it is manufactured in situ at an application site.

9. A pressure tank containing a gas mixture comprising a protective gas, selected from the group consisting of carbon dioxide, oxygen, hydrogen, nitrogen and mixtures thereof along with at least one inert component selected from the group consisting of argon, helium, argon-helium mixtures and noble gases and mixtures thereof, and mixtures of noble gases with argon and/or helium, and further comprising a protective gas additive selected from the group consisting of ethers, cyclic amines containing at least one ether group, and mixtures thereof.

10. The gas mixture according to claim 9, characterized in that the protective gas is selected from the group of dimethyl ether, ethyl methyl ether, diethyl ether and mixtures thereof.

11. The gas mixture according to claim 9, characterized in that the gas mixture contains from 0.0001% v/v to 10% v/v of the protective gas additive relative to the gas mixture.

12. An industrial processing method, in which a gas mixture is used for thermal spraying, cutting, joining, deposition welding and/or surface treatment by means of arcs, plasma and/or lasers, characterized in that the gas mixture comprises a protective gas, selected from the group consisting of carbon dioxide, oxygen, hydrogen, nitrogen and mixtures thereof along with at least one inert component selected from the group consisting of argon, helium, argon-helium mixtures and noble gases and mixtures thereof, and mixtures of noble gases with argon and/or helium, and further comprising a protective gas additive selected from the group consisting of ethers, cyclic amines containing at least one ether group, and mixtures thereof.

13. The industrial processing method according to claim 12, characterized in that the protective gas additive is dosed into the gas mixture on site.

14. The gas mixture according to claim 12, characterized in that the protective gas is selected from the group of dimethyl ether, ethyl methyl ether, diethyl ether and mixtures thereof.

15. The gas mixture according to claim 12, characterized in that the gas mixture contains from 0.0001% v/v to 10% v/v of the protective gas additive relative to the gas mixture.

16. A device for preparing a gas mixture comprising a protective gas, selected from the group consisting of carbon dioxide, oxygen, hydrogen, nitrogen and mixtures thereof along with at least one inert component selected from the group consisting of argon, helium, argon-helium mixtures and noble gases and mixtures thereof, and mixtures of noble gases with argon and/or helium, and further comprising a protective gas additive selected from the group consisting of ethers, cyclic amines containing at least one ether group, and mixtures thereof, comprising a tank containing liquid argon, nitrogen, carbon dioxide, hydrogen or helium or mixtures thereof and/or one or more pressure tanks containing argon, nitrogen, carbon dioxide, hydrogen or helium or mixtures thereof, a container that holds the protective gas additive, and lines that introduce a gas selected from the group consisting of argon, nitrogen, carbon dioxide, hydrogen, helium or mixtures thereof into a gas compartment of the container.

17. The device according to claim 16, characterized in that the container is temperature controlled.

18. The device according to claim 16, characterized in that the protective gas additive is dissolved in a solvent.

19. The device according to claim 16, characterized in that the lines guide a gas selected from the group consisting of argon, nitrogen, carbon dioxide, hydrogen, helium or mixtures thereof through the liquid in the container and relays the gas mixture to a consumer.

20. The device according to claim 16, characterized in that the protective gas is selected from the group of dimethyl ether, ethyl methyl ether, diethyl ether and mixtures thereof.

21. The device according to claim 16, characterized in that the gas mixture contains from 0.0001% v/v to 10% v/v of the protective gas additive relative to the gas mixture.

22. A method for manufacturing a gas mixture comprising a protective gas, selected from the group consisting of carbon dioxide, oxygen, hydrogen, nitrogen and mixtures thereof along with at least one inert component selected from the group consisting of argon, helium, argon-helium mixtures and noble gases and mixtures thereof, and mixtures of noble gases with argon and/or helium, and further comprising a protective gas additive selected from the group consisting of ethers, cyclic amines containing at least one ether group, and mixtures thereof, characterized in that a protective gas additive is filled into a pressure tank along with protective gas selected from the group consisting of carbon dioxide, oxygen, hydrogen, nitrogen, and mixtures thereof along with at least one inert component selected from the group consisting of argon, helium, argon-helium mixtures and noble gases and mixtures thereof, along with mixtures of noble gases with argon and/or helium.

23. The method according to claim 22, characterized in that the protective gas is selected from the group of dimethyl ether, ethyl methyl ether, diethyl ether and mixtures thereof.

24. The method according to claim 22, characterized in that the gas mixture contains from 0.0001% v/v to 10% v/v of the protective gas additive relative to the gas mixture.
